(19) United States
(12) Patent Application Publication
(10) Pub. No.: US 2015/0009136 A1
(43) Pub. Date: Jan. 8, 2015

(54) OPERATION INPUT DEVICE AND INPUT OPERATION PROCESSING METHOD

(71) Applicant: Sharp Kabushiki Kaisha, Osaka (JP)

(72) Inventor: Naoki KATO, Osaka-shi (JP)

(73) Assignee: Sharp Kabushiki Kaisha, Osaka (JP)

(21) Appl. No.: 14/250,642

(22) Filed: Apr. 11, 2014

(30) Foreign Application Priority Data
Jul. 2, 2013 (JP) 2013-139118

(51) Int. Cl. G06F 3/033; G06F 3/041

(52) U.S. Cl. CPC G06F 3/033; G06F 3/041; G06F 2203/0338
USPC 345/157

(57) ABSTRACT

The operation input device includes: an operation determination unit configured to determine which one of the floating touch operation and the touch operation is input; a calculation unit configured to calculate an input position of the operation on the operation panel; a display information generation unit configured to generate display information for displaying a pointer at a position on a display screen corresponding to an input position calculated by the calculation unit when the operation determination unit determines that the floating touch operation is input; and a display device output unit configured to output the display information generated by the display information generation unit to a display device having the display screen displaying the pointer.

### CROSS-REFERENCE TO RELATED APPLICATIONS

This Nonprovisional application claims priority under 35 U.S.C.§119(a) on Patent Application No. 2013-139118 filed in Japan on Jul. 2, 2013, the entire contents of which are hereby incorporated by reference.

### BACKGROUND

The present invention relates to an operation input device receiving an input of a floating touch operation and a touch operation, and an input operation processing method.

### DESCRIPTION OF THE RELATED ART

A touch panel display having a touch panel of the related art operates contents by receiving a touch operation on the touch panel and outputting touch information based on the received touch operation to source devices operated by the touch operation.

Further, relative mobile information (relative coordinate information) is transmitted to the source devices by operating a wireless mouse or a wireless pointing device on which an acceleration sensor is mounted; a mouse cursor, a pointer, or the like is displayed on a screen based on the mobile information; and a determination operation is performed at a desired position by a determination button, etc., thereby operating contents.

For example, Japanese Patent Application Laid-open No. 2002-91642 and No. H03-257520 disclose an apparatus to operate a cursor displayed on a display by operating a pointing device connected to the display. In particular, Japanese Patent Application Laid-open No. 2002-91642 discloses an apparatus to wirelessly connect the display to the pointing device.

### SUMMARY

However, in the case of the touch panel display, since a large touch panel is expensive and has a long visual distance and has a large operation object, the large touch panel is inadequate for the direct touch operation. Meanwhile, in the case of a wireless device using relative mobile information, since a pointer is displayed by calculating the relative mobile information or the coordinate information, it takes time to appoint a specific place on the screen and it is relatively difficult to appoint the specific place. Further, since there is a need to operate separate keys, etc., by a pointing operation and a determination operation, the operation is complicated.

In consideration of the above-mentioned circumstances, it is an object of the present invention to provide an operation input device and an input operation processing method which may have excellent operability and easily specify an operation position with a low cost configuration.

According to one aspect of the present invention, there is provided an operation input device including an operation panel configured to receive an input of a floating touch operation and a touch operation, including: an operation determination unit configured to determine which one of the floating touch operation and the touch operation is input; a calculation unit configured to calculate an input position of the operation on the operation panel; a display information generation unit configured to generate display information for displaying a pointer at a position on a display screen corresponding to an input position calculated by the calculation unit when the operation determination unit determines that the floating touch operation is input; and a display device output unit configured to output the display information generated by the display information generation unit to a display device having the display screen displaying the pointer.

According to another aspect of the present invention, there is provided an input operation processing method using an operation input device including an operation panel configured to receive an input of a floating touch operation and a touch operation, including steps of: determining which one of a floating touch operation and a touch operation is input; calculating an input position of the operation on the operation panel; if it is determined that the floating touch operation is input, generating display information for displaying a pointer at a position on a display screen corresponding to the calculated input position; and outputting the generated display information to a display device having the display screen displaying the pointer.

The operation input device according to the present invention may further include: a touch operation information generation unit configured to generate touch operation information based on the touch operation, if the operation determination unit determines that the touch operation is input, and a control device output unit configured to output the touch operation information generated by the touch operation information generation unit to a control device which is controlled by the touch operation or the floating touch operation.

The operation input device according to the present invention may further include: a floating touch operation information generation unit configured to generate floating touch operation information based on the floating touch operation, if the operation determination unit determines that the floating touch operation is input, wherein the control device output unit outputs the floating touch operation information generated by the floating touch operation information generation unit to the control device.

The operation input device according to the present invention may further include: a transformation unit configured to transform the input position calculated by the calculation unit into a display position on the display screen, based on a resolution on the display screen of the display device and a resolving power of the input position of the operation panel.

According to the present invention, it is possible to provide an excellent operability and easily specify an operation position with a low cost configuration.

The above and further objects and features will more fully be apparent from the following detailed description with accompanying drawings.

### BRIEF DESCRIPTION OF THE DRAWINGS

FIG. 1 is a block diagram illustrating an example of a configuration of an operation input device according to an embodiment of the present invention;

FIG. 2A is a diagram for explaining an example of an operation on an operation panel by a finger;

FIG. 2B is a diagram for explaining an example of an operation on an operation panel by a finger;

FIG. 3 is a diagram for explaining an example of a change in capacitance of an electrode within the operation panel;

FIG. 4 is a view for explaining an example of an input operation by an operation input device according to the embodiment of the present invention;

FIG. 5 is a block diagram for explaining a first example of a use state of the operation input device according to the embodiment of the present invention;

FIG. 6 is a block diagram for explaining a second example of the use state of the operation input device according to the embodiment of the present invention;

FIG. 7 is a flow chart illustrating an example of an input operation processing procedure by the operation input device according to the embodiment of the present invention; and

FIG. 8 is a flow chart illustrating an example of the input operation processing procedure by the operation input device according to the embodiment of the present invention.

### DETAILED DESCRIPTION

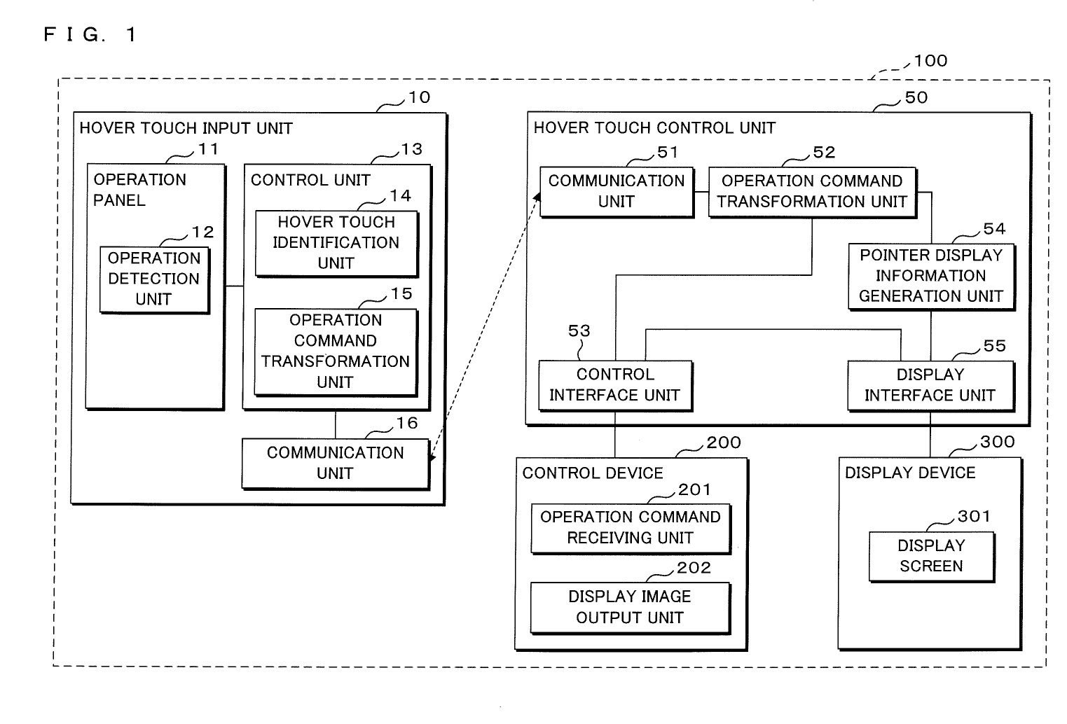

Hereinafter, embodiments of the present invention will be described with reference to the accompanying drawings. FIG. 1 is a block diagram illustrating an example of a configuration of an operation input device 100 according to an embodiment of the present invention. The operation input device 100 includes a hover touch input unit 10, a hover touch control unit 50 and the like. The hover touch input unit 10 and the hover touch control unit 50 are connected to each other by a wireless communication means such as a wireless LAN or Bluetooth (registered trademark). Further, the hover touch control unit 50 is connected to a control device 200, a display device 300 and the like.

The control device 200 includes an operation command receiving unit 201, a display image output unit 202 and the like. Further, the display device 300 includes a display screen 301 and the like. The display image output unit 202 outputs an image or a picture (moving picture, or still picture) which is displayed on the display screen 301 of the display device 300. That is, the control device 200 serves as a source device which outputs images or pictures (moving pictures, or still pictures) displayed on the display screen 301 of the display device 300.

The hover touch input unit 10 includes an operation panel 11, a control unit 13, a communication unit 16 and the like. The operation panel 11 includes an operation detection unit 12. Further, the control unit 13 includes a hover touch identification unit 14, an operation command transformation unit 15 and the like.

The operation panel 11 may be configured of, for example, a capacitive pad, and the like and receives an input of a floating touch operation and a touch operation. The operation panel 11 has, for example, a thin film structure in which an electrode pattern is formed on a flexible substrate. The floating touch operation or the touch operation by a finger, a pen, or the like may be determined by disposing a plurality of electrodes in the electrode pattern in two dimensions (for example, XY directions) and detecting the capacitance of the respective electrodes.

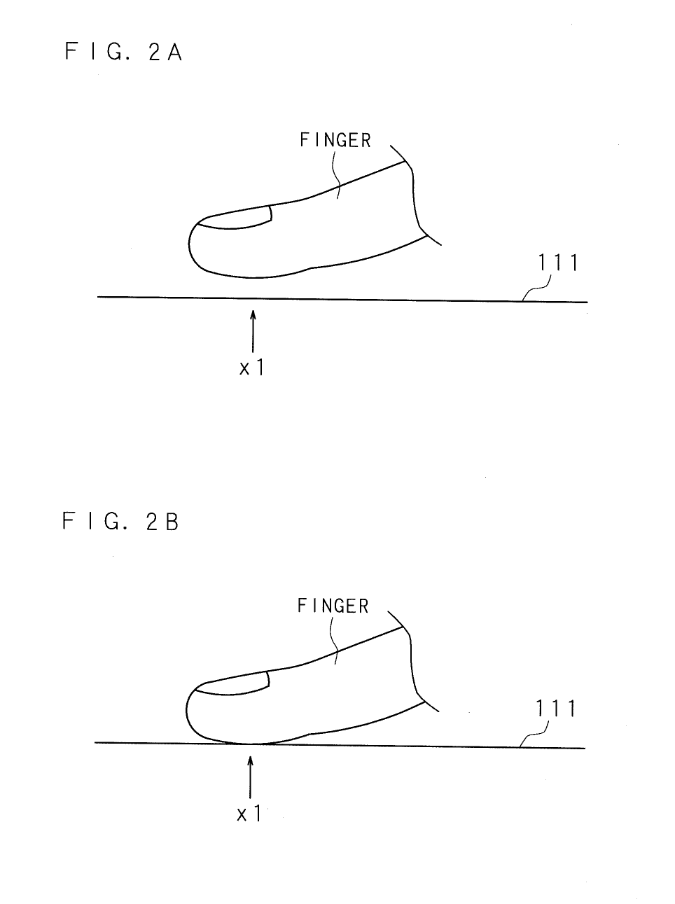

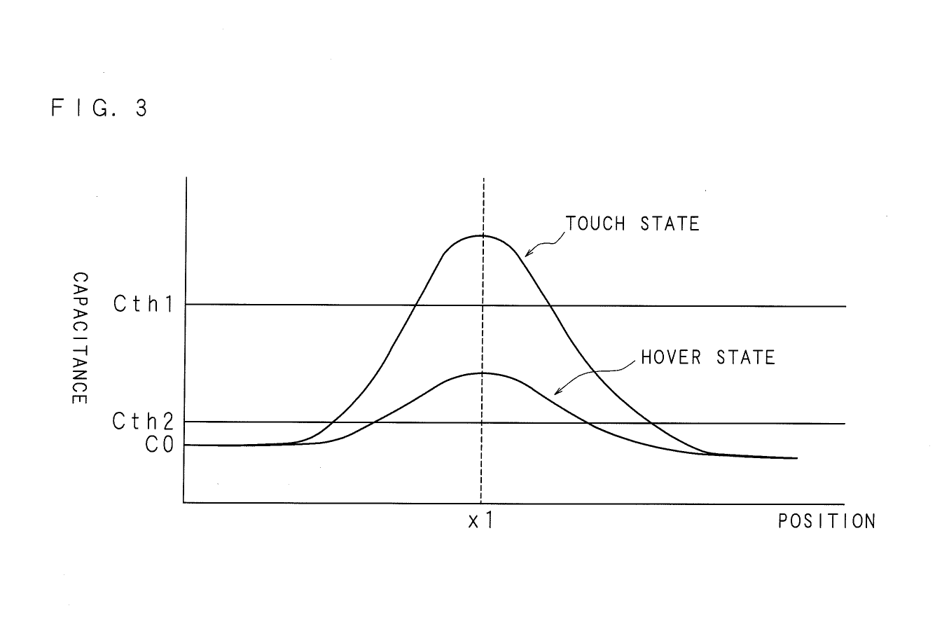

FIG. 2 is a diagram for explaining an example of an operation on the operation panel 11 by a finger and FIG. 3 is a diagram for explaining an example of a change in capacitance of an electrode within the operation panel 11. FIG. 2A illustrates an example of the floating touch operation. The floating touch operation is an operation in the state in which the finger, the pen, or the like does not directly contact a surface 111 of the operation panel 11 but approaches the surface 111 of the operation panel 11. In the example of FIG. 2A, the finger approaches a position marked by sign x1. The floating touch operation is an operation of the finger, the pen, or the like which is performed in the hover state and may include, for example, a hover operation, hover flick operation, a hover palm operation and the like. The detailed description of each operation will be described below. In the embodiment of the present invention, the floating touch operation is called a hover operation.

FIG. 2B illustrates an example of the touch operation. The touch operation is an operation in the state in which the finger, the pen, or the like directly contact the surface 111 of the operation panel 11. In the example of FIG. 2B, the finger contacts the position marked by the sign x1. The touch operation is an operation of the finger, the pen, or the like in the touch state and may include, for example, the touch operation (single touch operation), a multi-touch operation, a long touch operation, a flick operation and the like. The detailed description of each operation will be described below.

As illustrated in FIG. 3, when the finger contacts or approaches the position x1 of the operation panel 11, since a large capacitance is generated between the electrode of the operation panel 11 and the finger in the touch state, the capacitance in the vicinity of the position x1 exceeds a first threshold value Cth1. Further, the capacitance generated between the electrode of the operation panel 11 and the finger is increased in the hover state, but is smaller than that in the touch state. That is, in the hover state, the capacitance in the vicinity of the position x1 is smaller than the first threshold value Cth1 and exceeds a second threshold value Cth2 (<Cth1). Further, in FIG. 3, a capacitance CO is a capacitance in the state in which the finger does not approach the surface 111 of the operation panel 11.

The operation detection unit 12 serves as an operation determination unit to determine whether the operation input to the operation panel 11 is the hover operation or the touch operation. That is, the operation detection unit 12 detects the change in capacitance of each electrode of the operation panel 11 and detects whether the input of the hover operation or the touch operation is present or not.

Further, the operation detection unit 12 serves as a calculation unit to calculate the operation input position on the operation panel 11. As described above, when the finger, the pen, or the like approaches the operation panel 11, the capacitance is generated between the electrode and the fingers, such that as the electrode comes near the fingers, the capacitance may be increased. The operation input position may be calculated as an absolute coordinate on the operation panel 11 by detecting the change in capacitance of the electrode.

In more detail, the operation detection unit 12 detects a temporal change and a spatial change in capacitance. Thereby, the difference in the number of fingers, the motion of fingers, and the like may be detected. The operation detection unit 12 outputs the detected results (whether or not the input of the hover operation or the touch operation is present, the coordinate of the input position, the temporal and spatial change in capacitance, and the like) to the control unit 13.

The hover touch identification unit 14 identifies that the hover operation or the touch operation is input, based on the detected results output from the operation detection unit 12. In more detail, when the hover operation is input, the hover touch identification unit 14 may identify, for example, the hover operation, the hover flick operation, the hover palm operation and the like. Further, when the touch operation is input, the hover touch identification unit 14 may identify, for example, the touch operation (single touch operation), the multi-touch operation, the long touch operation, the flick operation and the like.

The operation command transformation unit 15 transforms the results identified by the hover touch identification unit 14 into operation command information. The operation command information is the command information such as the hover operation, the hover flick operation, the hover palm operation, the touch operation (single touch operation), the multi-touch operation, the long touch operation, the flick operation and the like.

The communication unit 16 has a wireless communication function such as a wireless LAN or Bluetooth (registered trademark) with a communication unit 51, and transmits the operation command information transformed by the operation command transformation unit 15 to the hover touch control unit 50.

The hover touch control unit 50 includes the communication unit 51, an operation command transformation unit 52, a control interface unit 53, a pointer display information generation unit 54, a display interface unit 55 and the like.

The communication unit 51 receives the operation command information transmitted from the hover touch input unit 10.

The operation command transformation unit 52 transforms the operation command information received by the communication unit 51 into a format corresponding to a control device 200 to generate the operation command. The operation command is to inform the control device 200 of a predetermined operation. For example, when as the control device 200, a personal computer with a mouse connected thereto is used, there is a need to inform the personal computer of operations such as a mouse movement and a left click, a right click, and a double click of the mouse. Further, in this case, the operation command transformation unit 52 may also perform processing of automatically transforming the positions (coordinates) of the mouse depending on a resolution of the display screen 301 of the display device 300.

The pointer display information generation unit 54 serves as a display information generation unit, and if it is determined that the floating touch operation is input, generates the display information for displaying a pointer at a position on the display screen 301 corresponding to the calculated input position.

The display information includes, for example, an image of the pointer, positional information of the pointer and the like. The image of the pointer is, for example, a mouse cursor image, and the like and is an image which represents a state in which the mouse cursor hovers in a region in which the click operation may be performed on the display screen. Further, the display information may be displayed as a state (added state) in which the display information overlaps the image or the picture output from the control device 200. Further, the positional information of the pointer may specify the position on the display screen 301 corresponding to the input position on the operation panel 11 as the absolution coordinate by previously defining a correspondence relationship between the coordinates on the operation panel 11 and the coordinates on the display screen 301.

The display interface unit 55 serves as a display device output unit to output the display information generated by the pointer display information generation unit 54 to the display device 300 having the display screen 301 displaying the pointer.

According to the foregoing configuration, when the hover operation is performed on the operation panel 11, the pointer may be displayed at the position (absolute coordinate) on the display screen 301 corresponding to the input position of the hover operation. Thereby, an expensive large touch panel need not be mounted in the display device and the input of the hover operation and the touch operation may be received with an operation panel having a relatively inexpensive configuration.

Further, since the input positions of both operations of the hover operation and the touch operation are calculated and the pointers are displayed at the positions on the display screen 301 corresponding to the calculated input positions, the operation at the absolute coordinate may be achieved, thereby easily specifying the operation positions.

Further, there is no need to perform an additional operation, such as pressing a specific key, and the hover state and the touch state of the pointer on the display screen 301 may be achieved by a series of operations of the hover operation and the touch operation, thereby improving operability.

Further, the operation command transformation unit 52 serves as the touch operation information generation unit and if it is determined that the touch operation is input, generates the touch operation information based on the input touch operation. The touch operation information generated by the operation command transformation unit 52 is an operation command transformed into the format corresponding to the control device 200 and is, for example, the operation command depending on the touch operation.

The control interface unit 53 serves as the control device output unit to output the operation command (operation command depending on the touch operation) transformed by the operation command transformation unit 52 to the control device 200.

The operation command receiving unit 201 of the control device 200 receives the operation command which the operation input device 100 outputs. The control device 200 performs an operation depending on the received operation command (operation command depending on the touch operation). According to the foregoing configuration, a user moves the pointer to a desired position by performing the hover operation on the operation panel 11 while keeping his/her eyes on the display screen 301 on which, for example, the pointer is displayed and then controls (operates) the control device 200 by performing the operation with the same sensation like directly touching the display screen 301 by the touch operation, thereby improving operability.

Further, the control interface unit 53 acquires the image or the picture output from the display image output unit 202 and outputs the acquired image or picture to the display interface unit 55. The display interface unit 55 outputs the image or the picture acquired by the control interface unit 53 to the display device 300.

Further, the operation command transformation unit 52 serves as the floating touch operation information generation unit and if it is determined that the hover operation is input, generates the hover operation information based on the input hover operation. The hover operation information generated by the operation command transformation unit 52 is the operation command transformed into the format corresponding to the control device 200 and is, for example, the operation command depending on the hover operation.

The control interface unit 53 outputs the operation command (operation command depending on the hover operation) transformed by the operation command transformation unit 52 to the control device 200.

The operation command receiving unit 201 of the control device 200 receives the operation command which the operation input device 100 outputs. The control device 200 performs the operation depending on the received operation command (operation command depending on the hover operation). According to the foregoing configuration, the user moves the pointer to the desired position by performing the hover operation on the operation panel 11 while keeping his/her eyes on the display screen 301 on which, for example, the pointer is displayed. Therefore, the control device 200 may be controlled (operated) with the same sensation such as directly performing the hover operation on the display screen 301, thereby improving operability.

Further, the operation detection unit 12 serves as the transformation unit to transform the calculated input position into the display position on the display screen 301 based on the resolution of the display screen 301 of the display device 300 and the resolving power (resolution) of the input position of the operation panel 11. Thereby, even in the case in which the resolutions are different between the operation panel 11 and the display screen 301 of the display device 300, the pointer may be displayed at the position on the display screen 301 corresponding to the position of the finger, the pen, or the like on the operation panel 11, and the pointer on the display screen 301 may move depending on the moving distance of the finger, the pen, or the like, on the operation panel 11, such that marks such as icons and buttons on the display screen 301 are intuitively operated, thereby improving operability.

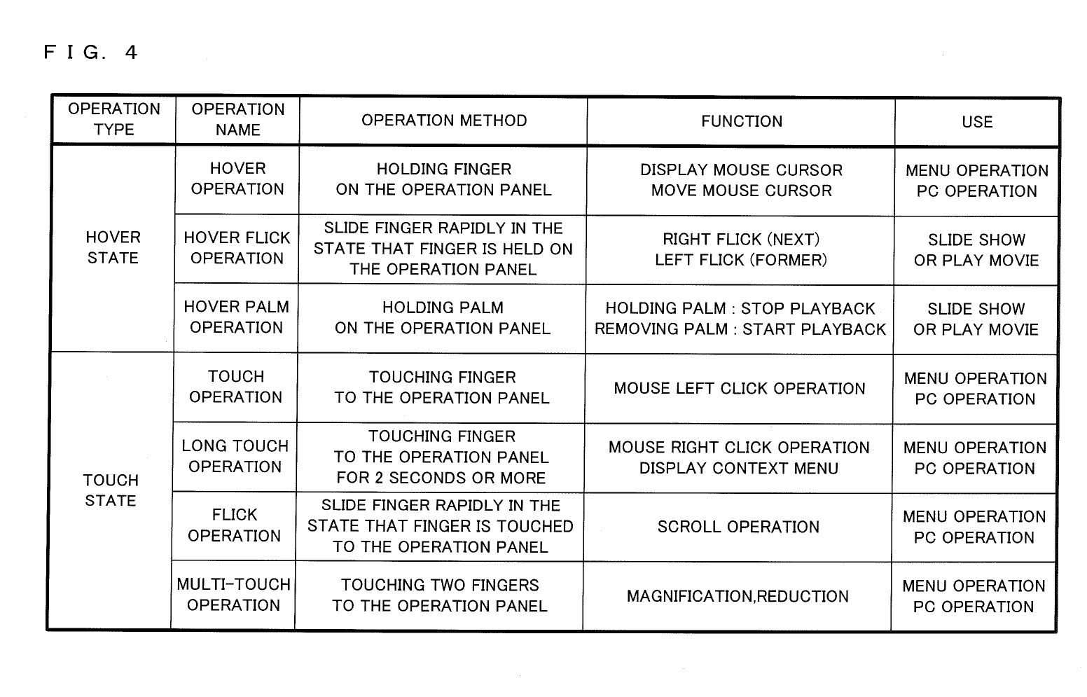

FIG. 4 is a view for explaining an example of the input operation by the operation input device 100 according to the embodiment of the present invention. As illustrated in FIG. 4, as a type of the input operation, there are a hover state and a touch state. As the hover state, there are, for example, the hover operation, the hover flick operation, the hover palm operation and the like.

The hover operation is an operation of holding a finger on the operation panel 11. As the function achieved by the operation command (for example, a hover command) corresponding to the hover operation, there are a function of displaying the mouse cursor, and a function of moving the mouse cursor. The use of the hover operation is a menu operation, when the control device 200 is, for example, an AV device corresponding to the touch operation. Further, when the control device 200 is a personal computer (PC), and the like, the use is a operation on the PC.

The hover flick operation is an operation to slide a finger rapidly in the state in which the finger is held on the operation panel 11. As the function achieved by the operation command (for example, a hover flick command) corresponding to the hover flick operation, there are a function to perform a right flick (next) operation, a function to perform a left flick (former) operation and the like. The use of the hover flick operation is a slide show or to play a movie or the like.

The hover palm operation is an operation of holding a palm on the operation panel 11. As a function achieved by the operation command (for example, a palm hover command) corresponding to the hover palm operation, there are a function to temporarily stop a playback when the palm is held, and a function to start a playback when the palm is removed. The use of the hover palm operation is a slide show or to play a movie or the like.

The touch operation is a so-called single touch operation and is an operation of touching the finger to the operation panel 11. As the function achieved by the operation command (for example, a touch command) corresponding to the touch operation, there are a function corresponding to a left click operation of the mouse and the like. The use of the touch operation is the same as that of the hover operation.

The long touch operation is an operation to touch the finger to the operation panel 11, for example, for 2 seconds or more. As the function achieved by the operation command (for example, a long touch command) corresponding to the long touch operation, there are a function corresponding to the right click operation of the mouse, a function to display a context menu and the like. The use of the long touch operation is the same as that of the hover operation.

The flick operation is an operation to slide a finger rapidly in the state in which the finger is touched to the operation panel 11. As the function achieved by the operation command (for example, a flick command) corresponding to the flick operation, there is a function corresponding to a scroll operation or the like. The use of the flick operation is the same as that of the hover operation.

The multi-touch operation is an operation to touch two fingers to the operation panel 11. As the function achieved by the operation command (for example, a multi-touch command) corresponding to the multi-touch operation, there are a magnification function, a reduction function and the like. The use of the flick operation is the same as that of the hover operation.

Further, FIG. 4 illustrates an example in which an operation to use one finger or two fingers is performed, but the number of fingers are not limited thereto and therefore an operation to use three and four fingers may be allowed.

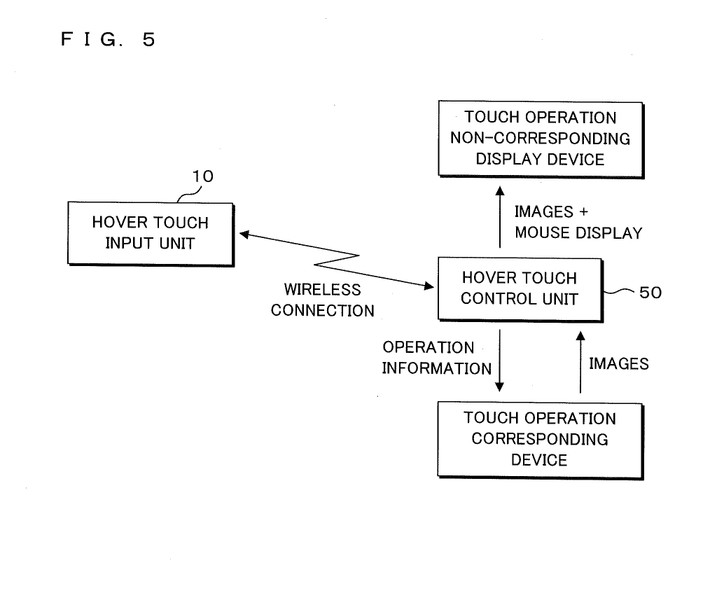

FIG. 5 is a block diagram for explaining a first example of a use state of the operation input device 100 according to the embodiment of the present invention. FIG. 5 illustrates an example in which, as the control device 200, a touch operation corresponding device (for example, a touch operation AV device), which may control the operation by the touch operation on the display screen is used, and as the display device 300, a touch operation non-corresponding display device is used. In this case, since the display device of FIG. 5 is the touch operation non-corresponding device, the display device may not control the operation of the touch operation corresponding device.

Therefore, the operation input device 100 according to the embodiment of the present invention is used. That is, the touch operation corresponding device outputs the image to the touch operation non-corresponding display device through the hover touch control unit 50. The hover operation or the touch operation performed by the hover touch input unit 10 is output to the touch operation corresponding device as the operation information (operation command) through the hover touch control unit 50. Further, the hover operation performed by the hover touch input unit 10 is output to the touch operation non-corresponding display device through the hover touch control unit 50 as the mouse display to display the mouse (pointer).

The hover touch control unit 50, based on the hover operation from the hover touch input unit 10, displays over the unique pointers (mouse display) to images from the source devices on the touch operation non-corresponding display device. Further, the hover touch control unit 50 outputs the hover operation and the touch operation performed by the hover touch input unit 10 to the touch operation corresponding device as the hover command and the touch command. Thereby, even when the touch operation non-corresponding display device is used, the operation of the touch operation corresponding device may be controlled.

As described above, in the example of FIG. 5, as cooperation with the AV device, the hover touch control unit 50 is placed between the source devices and the display device corresponding to the touch operation, and the hover touch control unit 50 receive the input (operation) from the hover touch input unit 10 wirelessly, and inform to the source devices. The hover touch control unit 50 outputs so as to overlap unique mouse cursors (pointers) as the operation input from the hover touch input unit 10 to the images input from the source devices to the display device, such that the hover operation and the touch operation may be wirelessly performed even in the case of the display device which does not correspond to the touch operation.

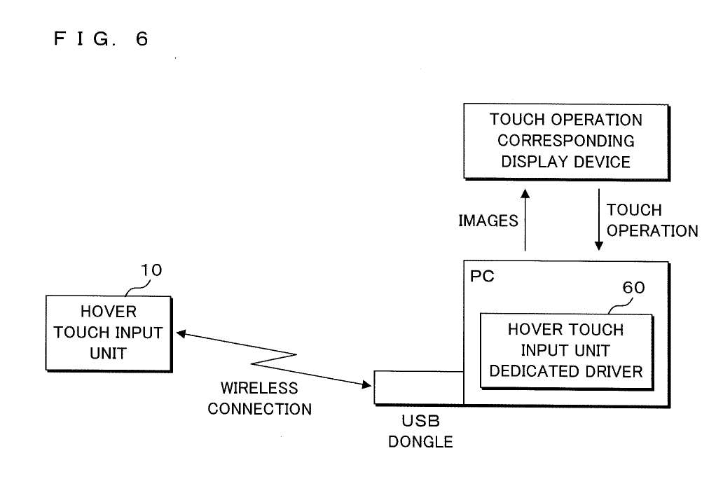

FIG. 6 is a block diagram for explaining a second example of a use state of the operation input device 100 according to the embodiment of the present invention. FIG. 6 illustrates an example in which as the control device 200, the personal computer (PC) is used, and as the display device 300, the touch operation corresponding display device is used. In this case, the operation of the PC may be controlled by performing the touch operation on the display screen of the display device, but the user needs to be located next to the display device so as to touch the display screen and therefore may not be away from the display device.

Therefore, the operation input device 100 according to the embodiment of the present invention is used. In this case, the function corresponding to the hover touch control unit 50 is achieved in a form of a so-called hover touch input unit dedicated driver 60 and the hover touch input unit dedicated driver 60 is installed in the PC. The hover touch input unit dedicated driver 60 may transmit an event from the hover touch input unit 10 to an operating system (OS) of the PC as a virtual mouse key event. Further, the hover touch input unit 10 may be wirelessly connected to the PC by inserting a USB dongle of a wireless receiver into the PC. Further, when the PC has a communication function such as the wireless LAN, the communication function having the PC embedded therein may be allowed. Thereby, the operation of the PC may be controlled at a location away from the display device.

As described above, in an example of FIG. 6, as cooperation with the PC: the PC is wirelessly connected to the hover touch input unit 10 by using the wireless receiver embedded in the PC or the externally attached USB dongle; the input of the hover operation and the touch operation is transformed by the PC dedicated driver; and a virtual mouse event and a virtual key event (gesture) are informed to the operating system (OS), such that the hover operation and the touch operation may be wirelessly performed.

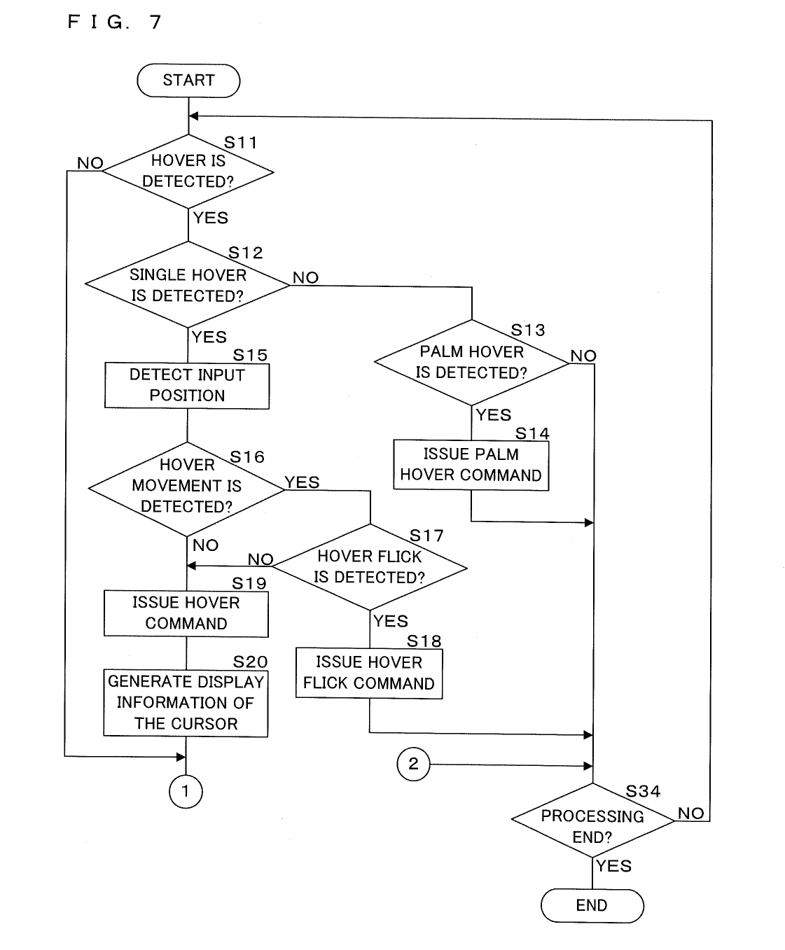

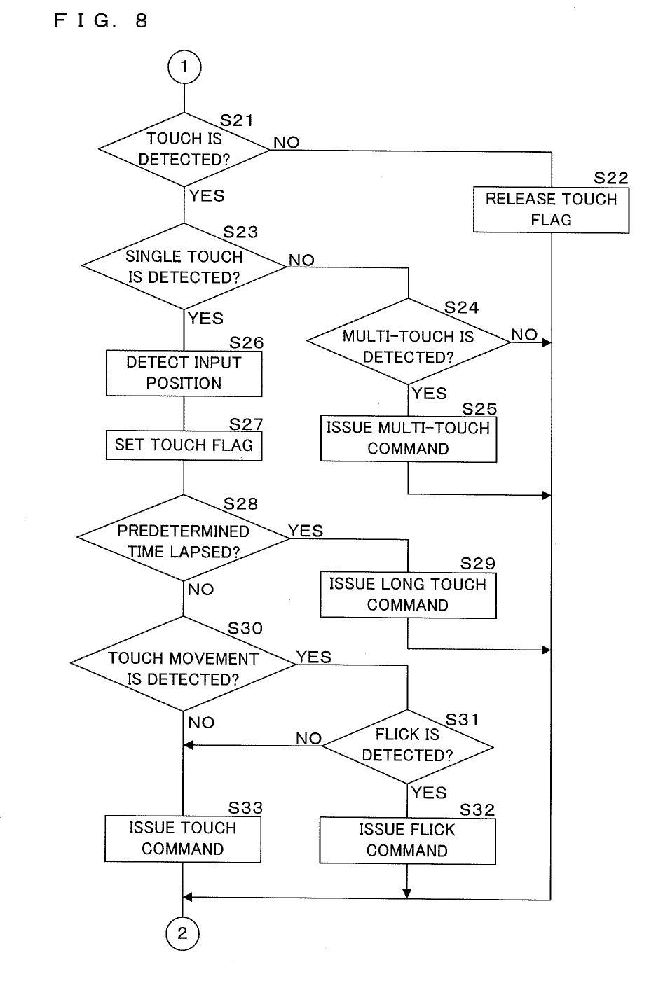

FIGS. 7 and 8 are flow charts illustrating an example of the input operation processing procedure by the operation input device 100 according to the embodiment of the present invention. The operation input device 100 determines whether the hover (hover operation) is detected (S11). The detection of the hover may be determined based on whether for example, as illustrated in FIG. 3, the electrode, of which the capacitance detected by the operation detection unit 12 is larger than the second threshold value Cth2 but smaller than the first threshold value Cth1, is present.

If it is determined that the hover is detected (YES in S11), the operation input device 100 determines whether the single hover (single hover operation) is detected (S12).

If it is determined that the single hover is not detected (NO in S12), the operation input device 100 determines whether the palm hover (hover palm operation) is detected (S13). If it is determined that the palm hover is detected (YES in S13), the operation input device 100 issues the palm hover command (gesture command of the palm hover) (S14) and performs processing of step S34 to be describe below. If it is determined that the palm hover is not detected (NO in S13), the operation input device 100 performs the processing of step S34 to be described below.

If it is determined that the single hover is detected (YES in S12), the operation input device 100 detects the input position (S15) and determines whether the hover movement is detected (S16). When the previous final input position is different from the input position this time, it may be determined that the hover movement is made.

If it is determined that the hover movement is detected (YES in S16), the operation input device 100 determines whether the hover flick (hover flick operation) is detected (S17).

If it is determined that the hover flick is detected (YES in S17), the operation input device 100 issues the hover flick command (gesture command of the hover flick) (S18) and performs the processing of step S34 to be described below.

If it is determined that the hover movement is not detected (NO in S16) or if it is determined that the hover flick is not detected when the hover is detected (NO in S17), the operation input device 100 issues the hover command (S19). The issuance of the hover command is used synonymously with the issuance of the mouse event. In this case, touch position coordinates are standardized using the resolution of the operation panel 11, touch coordinates are automatically transformed to meet the resolution of the display screen 301 of the display device 300, and then mouse coordinates are output.

The operation input device 100 generates the display information of the cursor (pointer) (S20). If it is determined that the hover is not detected (NO in S11), the operation input device 100 performs processing of step S21 to be described below.

The operation input device 100 determines whether the touch (touch operation) is detected (S21). The detection of the touch may be determined based on whether for example, as illustrated in FIG. 3, the electrode, of which the capacitance detected by the operation detection unit 12 is larger than the first threshold value Cth1, is present.

If it is determined that the touch is not detected (NO in S21), that is, the touch operation is not detected, the operation input device 100 releases a touch flag (S22) and performs the processing of step S34 to be described below. If it is determined that the touch is detected (YES in S21), the operation input device 100 determines whether the single touch (single hover operation) is detected (S23).

If it is determined that the single touch is not detected (NO in S23), the operation input device 100 determines whether the multi-touch (multi-touch operation) is detected (S24). If it is determined that the multi-touch is detected (YES in S24), the operation input device 100 issues the multi-touch command (gesture command of the multi-touch) (S25) and performs the processing of step S34 to be described below. If it is determined that the multi-touch is not detected (NO in S24), the operation input device 100 performs the processing of step S34 to be described below.

If it is determined that the single touch is detected (YES in S23), the operation input device 100 detects the input position (S26) and sets the touch flag (S27). The operation input device 100 determines whether a predetermined time (for example, 2 seconds, etc.) lapses in the touch state from the time of detecting the single touch (S28) and when the predetermined time lapses (YES in S28), issues the long touch command (gesture command of the long touch) (S29) and performs the processing of step S34 to be described below.

If it is determined that the predetermined time does not lapse (NO in S28), the operation input device 100 determines whether the touch movement is detected (S30). When the previous final input position is different from the input position this time, it may be determined that the touch movement is made.

If it is determined that the touch movement is detected (YES in S30), the operation input device 100 determines whether the flick (flick operation) is detected (S31). If it is determined that the flick is detected (YES in S31), the operation input device 100 issues the flick command (gesture command of the flick) (S32) and performs the processing of step S34 to be described below.

If it is determined that the touch movement is not detected (NO in S30) or if it is determined that the flick is not detected when the touch movement is detected (NO in S31), the operation input device 100 issues the touch command (gesture command of the touch) (S33) and performs the processing of step S34 to be described below. The operation input device 100 determines whether the processing ends (S34) and if it is determined that the processing does not end (NO in S34), repeats processing after step S11. If it is determined that the processing ends (YES in S34), the operation input device 100 ends the processing.

As described above, according to the operation input device 100 of the embodiment of the present invention, when the hover operation (floating touch operation) or the touch operation is performed on the operation panel 11 of the hover touch input unit 10, the gesture operation (gesture using a finger or a palm) including the hover operation and the touch operation is identified and as the mouse movement, the left click of the mouse, the right click of the mouse, or the gesture operation, operation command is performed by the control device 200. In the case that the control device 200 is the source device such as, for example, the personal computer, the smart phone, or the like, the operation information and the input coordinates of the mouse and the touch are informed to the operating system (OS) of the source device and thus the operating system, that is, the driver or the application performs the determination of the long touch, the gesture operation or the like. According to the embodiment of the present invention, the expensive large touch panel need not be mounted in the display device and the user may perform the touch operation and the hover operation at the specific coordinate at the location away from the display device as in the case in which the touch panel is added to the display screen.

According to the embodiment of the present invention, the sampling period or the number of touches (number of multi-touches) at the time of the detection of the touch and hover of the operation panel 11 may be automatically changed depending on the size of the display screen 301 of the display device 300. Thereby, the followability of the touch operation is optimal and thus the operability may be improved.

The operation input device 100 according to one aspect of the present invention including an operation panel 11 configured to receive an input of a floating touch operation and a touch operation, is characterized by including: operation determination units 12 and 14 configured to determine which one of the floating touch operation and the touch operation is input; a calculation unit 12 configured to calculate an input position of the operation on the operation panel; a display information generation unit 54 configured to generate display information for displaying a pointer at a position on a display screen 301 corresponding to an input position calculated by the calculation unit when the operation determination unit determines that the floating touch operation is input; and a display device output unit 55 configured to output the display information generated by the display information generation unit to a display device 300 having the display screen displaying the pointer.

The operation processing method according to another aspect of the present invention using an operation input device 100 including an operation panel 11 configured to receive an input of a floating touch operation and a touch operation, is characterized by including steps of: determining which one of a floating touch operation and a touch operation is input; calculating an input position of the operation on the operation panel; if it is determined that the floating touch operation is input, generating display information for displaying a pointer at a position on a display screen 301 corresponding to the calculated input position; and outputting the generated display information to a display device 300 having the display screen displaying the pointer.

According to the embodiment of the present invention, the operation determination units 12 and 14 determine whether the operation input to the operation panel corresponds to any of the floating touch operation and the touch operation. The touch operation is an operation in the state in which the finger, the pen, and the like directly contact the surface of the operation panel and the floating touch operation is an operation in an approach state without the finger, the pen, or the like directly contacting the surface of the operation panel. The operation panel may determine the floating touch operation or the touch operation by the finger, the pen, or the like, by detecting, for example, the capacitance of the respective electrodes which are mounted in the operation panel.

The calculation unit 12 calculates the operation input position on the operation panel. When the finger, the pen, or the like approaches the operation panel, the capacitance is generated between the electrode and the fingers, such that as the electrode comes near the fingers, the capacitance may be increased. The operation input position may be calculated as the absolute coordinate on the operation panel by detecting the change in capacitance.

If the operation determination unit determines that the floating touch operation is input, the display information generation unit 54 generates the display information for displaying the pointer at the position on the display screen 301 corresponding to the input position calculated by the calculation unit. The display information includes, for example, the image of the pointer, the positional information of the pointer and the like. The image of the pointer is, for example, the mouse cursor image, and the like, and is the image which represents the state in which the mouse cursor hovers in the region in which the click operation may be performed on the display screen. The positional information of the pointer may specify the position on the display screen corresponding to the input position on the operation panel as the absolute coordinate by previously defining the correspondence relationship between the coordinates on the operation panel and the coordinates on the display screen.

A display device output unit 55 outputs the display information generated from the display information generation unit to the display device 300 having the display screen 301 displaying the pointer.

According to the foregoing configuration, when the floating touch operation is performed on the operation panel, the pointer may be displayed at the position (absolute coordinate) on the display screen corresponding to the input position of the floating touch operation. Thereby, the expensive large touch panel need not be mounted in the display device and the input of the floating touch operation and the touch operation may be received with an operation panel having a relatively inexpensive configuration. Further, since the input positions of both operations of the floating touch operation and the touch operation are calculated and the pointers are displayed at the positions on the display screen corresponding to the calculated input positions, the operation at the absolute coordinate may be achieved, thereby easily specifying the operation positions. Further, there is no need to perform the additional operation, such as pressing the specific key, and the hover state and the touch state of the pointer on the display screen may be achieved by a series of operations of the floating touch operation and the touch operation, thereby improving operability.

The operation input device according to the embodiment of the present invention is characterized by further including: if the operation determination units 12 and 14 determines that the touch operation is input, touch operation information generation units 15 and 52 configured to generate touch operation information based on the touch operation, and a control device output unit 53 configured to output the touch operation information generated by the touch operation information generation unit to a control device 200 which is controlled by the touch operation or the floating touch operation.

According to the embodiment of the present invention, if the operation determination units 12 and 14 determine that the touch operation is input, the touch operation information generation units 15 and 52 generate the touch operation information based on the corresponding touch operation. As the touch operation, there may be, for example, the touch operation (single touch operation), the multi-touch operation, the long touch operation, the flick operation, and the like, in which the touch operation information is the operation command information depending on, for example, the touch operation. The control device output unit 53 outputs the touch operation information generated by the touch operation information generation unit to the control device 200 which is controlled by the touch operation or the floating touch operation. Thereby, the user moves the pointer to a desired position by performing the hover operation on the operation panel while keeping his/her eyes on the display screen on which, for example, the pointer is displayed and then controls (operates) the control device by performing the operation with the same sensation like directly touching the display screen by the touch operation, thereby improving operability.

The operation input device according to the embodiment of the present invention is characterized by further including: if the operation determination unit determines that the floating touch operation is input, floating touch operation information generation units 15 and 52 configured to generate floating touch operation information based on the floating touch operation, wherein the control device output unit 53 outputs the floating touch operation information generated by the floating touch operation information generation unit to the control device 200.

According to the embodiment of the present invention, if the operation determination units 12 and 14 determine that the floating touch operation is input, the floating touch operation information generation units 15 and 52 generate the floating touch operation information based on the input floating touch operation. As the floating touch operation, there may be, for example, the hover operation, the hover flick operation, the hover palm operation, and the like, in which the touch operation information is, for example, the operation command information depending on the floating touch operation. The control device output unit 53 outputs the floating touch operation information generated by the floating touch operation information generation unit to the control device 200. Thereby, the user moves the pointer to a desired position by performing the hover operation on the operation panel while keeping his/her eyes on the display screen on which, for example, the pointer is displayed and then controls (operates) the control device by performing the operation with the same sensation like directly touching the display screen by the touch operation, thereby improving operability.

The operation input device according to the embodiment of the present invention is characterized by further including: a transformation unit 12 configured to transform an input position calculated by the calculation unit 12 into a display position on the display screen, based on a resolution on the display screen 301 of the display device 300 and a resolving power of the input position of the operation panel 11.

According to the embodiment of the present invention, the transformation unit 12 transforms the input position calculated by the calculation unit 12 into the display position on the display screen, based on the resolution of the display screen 301 of the display device 300 and the resolving power (resolution) of the input position of the operation panel 11. Thereby, even in the case in which the resolutions are different between the operation panel and the display screen of the display device, the pointer may be displayed at the position on the display screen corresponding to the position of the finger, the pen, or the like on the operation panel and the pointer on the display screen may move depending on the moving distance of the finger, the pen, or the like, on the operation panel, such that the marks such as the icons or the buttons on the display screen are intuitively operated, thereby improving operability.

As this description may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An operation input device including an operation panel configured to receive an input of a floating touch operation and a touch operation, comprising:
an operation determination unit configured to determine which one of the floating touch operation and the touch operation is input;
a calculation unit configured to calculate an input position of the operation on the operation panel;
a display information generation unit configured to generate display information for displaying a pointer at a position on a display screen corresponding to an input position calculated by the calculation unit when the operation determination unit determines that the floating touch operation is input; and
a display device output unit configured to output the display information generated by the display information generation unit to a display device having the display screen displaying the pointer.

2. The operation input device according to claim 1, further comprising: a touch operation information generation unit configured to generate touch operation information based on the touch operation, if the operation determination unit determines that the touch operation is input, and
a control device output unit configured to output the touch operation information generated by the touch operation information generation unit to a control device which is controlled by the touch operation or the floating touch operation.

3. The operation input device according to claim 2, further comprising: a floating touch operation information generation unit configured to generate floating touch operation information based on the floating touch operation, if the operation determination unit determines that the floating touch operation is input,
wherein the control device output unit outputs the floating touch operation information generated by the floating touch operation information generation unit to the control device.

4. The operation input device according to claim 1, further comprising: a transformation unit configured to transform the input position calculated by the calculation unit into a display position on the display screen, based on a resolution on the display screen of the display device and a resolving power of the input position of the operation panel.

5. The operation input device according to claim 2, further comprising: a transformation unit configured to transform the input position calculated by the calculation unit into a display position on the display screen, based on a resolution on the display screen of the display device and a resolving power of the input position of the operation panel.

6. The operation input device according to claim 3, further comprising: a transformation unit configured to transform the input position calculated by the calculation unit into a display position on the display screen, based on a resolution on the display screen of the display device and a resolving power of the input position of the operation panel.

7. An input operation processing method using an operation input device including an operation panel configured to receive an input of a floating touch operation and a touch operation, comprising steps of:
determining which one of a floating touch operation and a touch operation is input;
calculating an input position of the operation on the operation panel;
if it is determined that the floating touch operation is input, generating display information for displaying a pointer at a position on a display screen corresponding to the calculated input position; and
outputting the generated display information to a display device having the display screen displaying the pointer.
